(19) United States
(12) Patent Application Publication
(10) Pub. No.: US 2017/0336903 A1
(43) Pub. Date: Nov. 23, 2017

(54) TOUCH AND PRESSURE SENSITIVE SURFACE WITH HAPTIC METHODS FOR BLIND PROBE ALIGNMENT

(71) Applicants: Daniel Rivaud, Ottawa (CA); Michael Gazier, Ottawa (CA)

(72) Inventors: Daniel Rivaud, Ottawa (CA); Michael Gazier, Ottawa (CA)

(73) Assignee: Ciena Corporation, Hanover, MD (US)

(21) Appl. No.: 15/158,923

(22) Filed: May 19, 2016

(51) Int. Cl. G06F 3/041; G06F 3/01; B60K 35/00; G06F 3/0488; G06F 3/044

(52) U.S. Cl. CPC G06F 3/0416; G06F 3/04886; G06F 3/044; G06F 3/0414; B60K 35/00; G06F 3/016; G06F 3/0412; B60K 2350/1028; B60K 2350/928

(57) ABSTRACT

A method may include detecting a position of a first probe based on a placement of the first probe relative to a first zone on a surface of a device, obtaining a first target position for the first probe in the first zone, comparing the position of the first probe to the first target position, and generating a first haptic response to guide the first probe toward the first target position when the position of the first probe is outside a first predetermined tolerance relative to the first target position. The first haptic response may vary with the position of the first probe.

### BACKGROUND

Electronic devices provide various forms of feedback. Haptic feedback has been increasingly incorporated in mobile electronic devices, such as mobile telephones, personal digital assistants (PDAs), portable gaming devices, and a variety of other mobile electronic devices. Haptic feedback engages the sense of touch through the application of force, vibration, or motion, and may be useful in guiding user behavior and/or communicating information to the user about device-related events. Haptic feedback can be especially useful when visual feedback is limited or unavailable.

Increasingly, mobile devices are moving away from physical buttons in favor of touchscreen interfaces, where a physical interface (e.g., keys on a keyboard, or buttons on a device) can be simulated with haptics. Physical keyboards provide means for guiding the placement of fingers, such as concave shapes of keys, ridges at key edges, and nibbles on the “F” and “J” keys. In contrast, touchscreen keyboards do not provide a way for users to know where their fingers are other than direct visual feedback. It can be very difficult to touch-type quickly using an on-screen virtual keyboard. For example, some tablet keyboards require the user to hover his or her hands over the keyboard because even the lightest touch causes a keypress. However, hovering one's hands causes the hand to drift and requires constant visual realignment of fingers and keys.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including detecting a position of a first probe based on a placement of the first probe relative to a first zone on a surface of a device, obtaining a first target position for the first probe in the first zone, comparing the position of the first probe to the first target position, and generating a first haptic response to guide the first probe toward the first target position when the position of the first probe is outside a first predetermined tolerance relative to the first target position. The first haptic response varies with the position of the first probe.

In general, in one aspect, one or more embodiments relate to a device including a surface configured to contact a first probe, a position sensor configured to detect a position of the first probe based on a placement of the first probe relative to a first zone on the surface, a processor comprising an alignment engine configured to obtain a first target position for the first probe in the first zone, compare the position of the first probe to the first target position, and determine that the position of the first probe is outside a first predetermined tolerance relative to the first target position, and a plurality of vibrating actuators, configured to generate a first haptic response to guide the first probe toward the first target position when the position of the first probe is outside a first predetermined tolerance relative to the first target position. The first haptic response varies with the position of the first probe.

In general, in one aspect, one or more embodiments of the invention relate to a processing system for a device including a sensor analysis engine configured to analyze sensor data to compute the position of a first probe and to interpret input from the first probe, an alignment engine configured to obtain a first target position for the first probe in the first zone, compare the position of the first probe to the first target position, and determine that the position of the first probe is outside a first predetermined tolerance relative to the first target position, and a feedback generator configured to generate a first haptic response to guide the first probe toward the first target position when the position of the first probe is outside a first predetermined tolerance relative to the first target position. The first haptic response varies with the position of the first probe.

Other aspects of the invention will be apparent from the following description and the appended claims.

### BRIEF DESCRIPTION OF DRAWINGS

FIG. 1 shows a system in accordance with one or more embodiments of the invention.

FIG. 2 and FIG. 3 show flowcharts in accordance with one or more embodiments of the invention.

FIG. 4 and FIG. 5 show examples in accordance with one or more embodiments of the invention.

FIG. 6 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to a method, device and processing system utilizing a touch and pressure sensitive surface for detecting the position of and input from one or more probes, where probe placement is detected via light touch and probe input is detected via heavy touch (e.g., pressing down on the surface with force). The touch and pressure sensitive surface may be deployed in a wide variety of devices, ranging from touchscreen keyboards to faceplates on various types of equipment. The probe may be a human finger or mechanical probe, such as a stylus, or a robotic appendage, among other possibilities. The touch and pressure sensitive may deliver a haptic response to a probe, for example, to guide a probe toward a target position on the surface. In one or more embodiments of the invention, the haptic response may be modulated, and may include multiple distinct responses, each guiding an individual probe to a target position. The haptic response may be localized within a specific zone on the device surface, or the haptic response may span the entire device. The haptic response may depend on a task associated with a zone and/or probe, as well as on the motion of the probe. In one or more embodiments, instead of aligning the position of the probe relative to a zone, the position of the zone itself may be aligned relative to the probe.

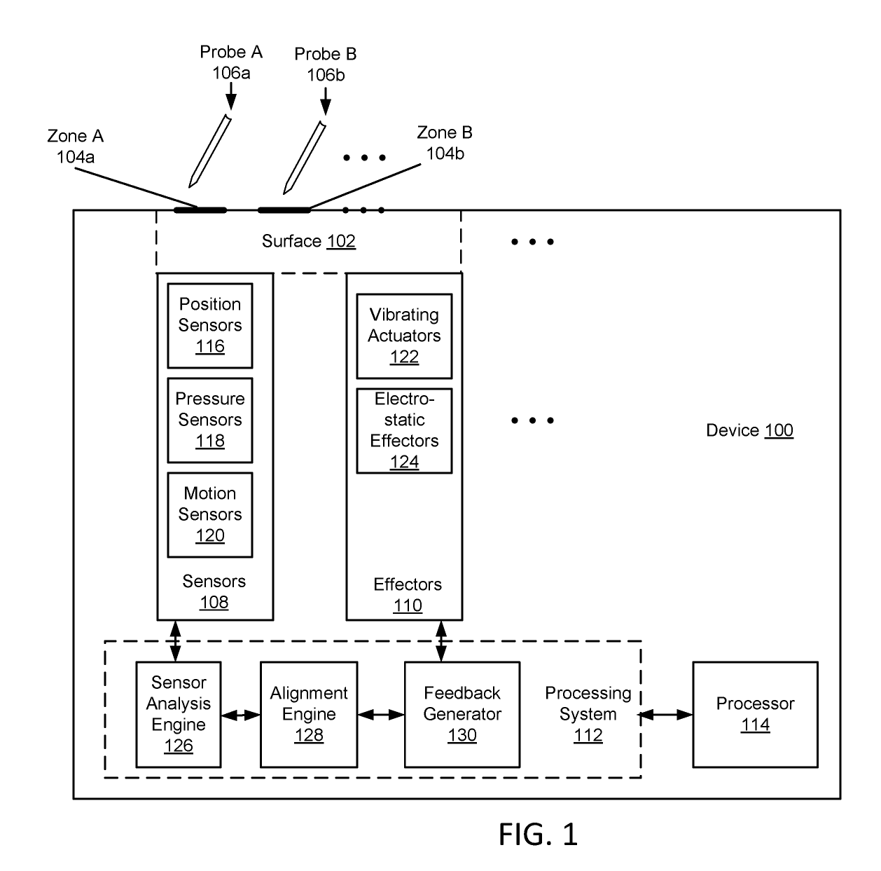

FIG. 1 shows a device (100) in accordance with one or more embodiments of the invention. As shown in FIG. 1, in one or more embodiments of the invention, the device (100) includes a surface (102), which contacts one or more probes (e.g., 106a, 106b). In one or more embodiments of the invention, the device (100) also includes one or more sensors (108), one or more effectors (110), a processing system (112) and a processor (114). Each of these components is described below.

In one or more embodiments of the invention, a device (100) is any device and/or any set of devices (e.g., a distributed computing system) capable of electronically processing instructions, serially or in parallel, and that includes at least the minimum processing power, memory, cache(s), input and output device(s), operatively connected storage device(s) and/or network connectivity in order to contribute to the performance of at least some portion of the functionality described in accordance with one or more embodiments of the invention. Examples of devices include, but are not limited to, one or more server machines (e.g., a blade server in a blade server chassis), desktop computers, mobile devices (e.g., laptop computer, smartphone, personal digital assistant, tablet computer, and/or any other mobile computing device), various types of industrial equipment (e.g., telecommunications equipment, routers, switches, various types of capital equipment, any other type of device used in communications, manufacturing, and/or any device used for an industrial purpose), various types of consumer-facing equipment (e.g., major appliances, such as refrigerators, stoves, televisions, radios, set-top-boxes, laundry machines), vehicle components (e.g., instrument panels and steering wheels), any other type of device with the aforementioned minimum requirements, and/or any combination of the listed examples. In one or more embodiments of the invention, a device includes hardware, software, firmware, circuitry, integrated circuits, circuit elements implemented using a semiconducting material, registers, caches, memory controller(s), cache controller(s) and/or any combination thereof.

In one or more embodiments of the invention, each surface (102) contains one or more zones (e.g., 104a, 104b) at which probe (e.g., 106a, 106b) input may be detected and feedback may be provided. In one or more embodiments of the invention, the surface (102) and its zones (e.g., 104a, 104b) may be flat, spherical, or any other two-dimensional or three-dimensional shape, and may be constructed from any materials capable of supporting sensors (108) and effectors (110), including but not limited to: encasings, plastics, flexible glasses, various polymers. Keys on a virtual, on-screen keyboard, or a physical keyboard are examples of zones (e.g., 104a, 104b) on a surface (102). In one or more embodiments of the invention, the zones (e.g., 104a, 104b) on a surface (102) may be reconfigured to support different tasks to be performed by one or more probes (e.g., 106a, 106b) on the device (100), where different zones (e.g., 104a, 104b) may be assigned different functions during the execution of different tasks. For example, a specific zone (e.g., 104a, 104b) on a piece of industrial equipment may correspond to the initiation of a test or repair sequence during a maintenance task, but may correspond to the initiation of a normal operating sequence otherwise. In one or more embodiments of the invention, a zone (e.g., 104a, 104b) may exist on a virtual surface (e.g., a virtual zone in the context of a video game, or a virtual zone on a faceplate of industrial equipment).

In one or more embodiments of the invention, the number and layout of the zones (e.g., 104a, 104b) may vary depending on the task. For example, once a normal operation sequence on a piece of industrial equipment is initiated, a restricted zone configuration may be displayed that permits the operation sequence to be paused, canceled, resumed, or restarted. Another example of zones (e.g., 104a, 104b) on the surface (102) of a piece of industrial equipment is blades in a server rack, where a haptic zone (e.g., 104a, 104b) may exist on the surface of the latch that is pulled to remove the blade.

Different types of probes (e.g., 106a, 106b) may interact with the device (100), including but not limited to: fingers, hands, styli, local and remote pointing devices, and robotic probes. In one or more embodiments of the invention, a probe (e.g., 106a, 106b) may have a probe type (e.g., index finger). In one or more embodiments of the invention, a probe (e.g., 106a, 106b) has a signature area corresponding to the size and shape of the area of the zone (e.g., 104a, 104b) covered by the probe (e.g., 106a, 106b) when the probe (e.g., 106a, 106b) touches the zone (e.g., 104a, 104b). For example, the signature area of an index finger is larger than the signature area of a ring finger. In one or more embodiments of the invention, there may be a predetermined home position for each probe (e.g., 106a, 106b), relative to a zone (e.g., 104a, 104b), and/or there may be a predetermined home position for each probe (e.g., 106a, 106b) relative to one or more other probes (e.g., 106a, 106b). In one or more embodiments of the invention, the predetermined home position may be based on adjacency relationships between probe types (e.g., the index finger to the right of the middle finger, relative to an orientation of the palm). In one or more embodiments, multiple probes (e.g., 106a, 106b) may interact with a single zone (e.g., 104a, 104b).

The device (100) may utilize any combination of sensor components and sensing technologies to detect probe (e.g., 106a, 106b) input, including but not limited to capacitive, elastive, resistive, inductive, magnetic, acoustic, ultrasonic, and/or optical techniques. In one or more embodiments of the invention, sensors (108) coupled to the device's surface (102) receive input from one or more probes (e.g., 106a, 106b). The sensor(s) (108) may include one or more position sensors (116), one or more pressure sensors (118) and one or more motion sensors (120). In various embodiments, sensors (108) (and effectors (110)) may reside within surfaces of casings (e.g., where face sheets may be applied over sensor electrodes or any casings, etc.).

In one or more embodiments of the invention, one or more position sensors (116) detect the position of a probe (e.g., 106a, 106b) when a probe (e.g., 106a, 106b) is placed on the surface (102) of the device (100). In some capacitive implementations of the one or more position sensors (116), voltage or current is applied to create an electric field. Nearby probes (e.g., 106a, 106b) cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive. 3D touch techniques may use capacitive sensing to detect and measure the deflection of a pliable glass layer.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may be a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

In one or more embodiments of the invention, pressure sensors (118) detect input from a probe (e.g., 106a, 106b) when the pressure exerted by the probe (e.g., 106a, 106b) on the surface of the device (100) exceeds a threshold level. In one or more embodiments of the invention, pressure sensors (118) may be based on resistive implementations, where a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine the presence of user input. Alternatively, pressure sensors (118) may be implemented using strain gauges on glass, where the inflection of the glass itself is used to infer the level of pressure or force. Such strain gauges (or other force sensors) may be placed at the corners of the surface or zone, where triangulation of the strain gauge sensors may be used to determine the location where the pressure originates.

Motion sensors (120) may be used to detect the velocity, acceleration and/or torque of a probe (e.g., 106a, 106b). The motion of the probe (e.g., 106a, 106b) may be interpreted (e.g., as a gesture) by the processing engine (112) to adjust the response provided by the effectors (110).

Sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In one or more embodiments of the invention, fingerprint or other biometric sensors (108) may be used to authenticate the identity of a probe (e.g., 106a, 106b). In one or more embodiments of the invention, effectors (110) include vibrating actuators (122) and electrostatic effectors (124). The vibrating actuators (122) may be used to deliver feedback, in the form of a haptic signal, to a zone on the surface (102) of the device (100). In one or more embodiments of the invention, electrostatic effectors (124) deliver feedback, in the form of an electrostatic signal, to a zone on the surface (102) of the device (100). Alternatively, other types of effectors (110) may provide auditory responses and/or other types of non-visual feedback.

In one or more embodiments of the invention, the haptic response may be generated using a grid of vibrating actuators (122) in a haptic layer beneath the surface (102) of the device (100). The top surface of the haptic layer may be situated adjacent to the bottom surface of an electrical insulated layer, while the bottom surface of the haptic layer may be situated adjacent to a display. Each vibrating actuator (122) may further include at least one piezoelectric material, Micro-Electro-Mechanical Systems (“MEMS”) element, electromagnet, thermal fluid pocket, MEMS pump, resonant device, variable porosity membrane, laminar flow modulation, or other assembly that may be actuated to move the surface (102) of the device (100). In one or more embodiments, providing haptic feedback to a probe (e.g., 106a, 106b) touching the surface (102) may be achieved by moving the surface (102) relative to probe (e.g., 106a, 106b). Each vibrating actuator (122) may be configured to provide a haptic effect independent of other vibrating actuators (122). Each vibrating actuator (122) may be adapted to be activated independently of the other vibrating actuators (122).

A haptic keyboard may be imprinted on a plastic or metal surface without a display or with the display located in a different physical location. For example, the faceplate of a piece of equipment could provide haptic feedback in a zone (e.g., 104a, 104b) to facilitate proper finger and/or hand (i.e., probe (e.g., 106a, 106b)) alignment. A haptic zone (e.g., 104a, 104b) located on a faceplate could indicate that the technician is pulling the correct card in a multi-blade chassis. A haptic zone (e.g., 104a, 104b) could also be located on a card's latch to indicate a problem (e.g., the card has not finished software shutdown or the paired latch has not been disengaged). One or more haptic zones (e.g., 104a, 104b) located within a card's faceplate could indicate that the technician is pulling the correct pluggable from a particular card or “pizza box”, and that the technician's fingers are located correctly relative to the surface (102). A haptic “head shaking ‘no’” could indicate the wrong card is being removed, or that the user's hands are pushing a card into a slot at an incorrect location, or that the user's fingers are not in proper alignment.

A “keyboard” surface (102) may include a small number of “keys” (zones (e.g., 104a, 104b)), even 1 key. A zone (e.g., 104a, 104b) may also be a removable piece of equipment such as a fiber or electrical connector. A keyboard may also be a switch, such as an on/off switch. Other examples of zones (e.g., 104a, 104b) are musical keyboards (e.g., for piano or guitar), and even virtual keyboards on an automotive instrument panel or hands-free steering wheel.

In one or more embodiments of the invention, the haptic response may be customized by a user of the device (100), for example, by setting the frequency, amplitude and/or pulse width of the haptic response. Alternatively, the user may select from a menu of haptic responses (analogous to selecting ringtones), and assign different haptic responses to different zones (e.g., 104a, 104b).

In one or more embodiments of the invention, a processing system (112) coupled to the device (100) analyzes data obtained by the sensors (108) and generates feedback to be delivered via the effectors (110) to the surface (102) of the device (100). In one or more embodiments of the invention, the processing system (112) includes a sensor analysis engine (126), an alignment engine (128) and a feedback generator (130).

In one or more embodiments of the invention, the processing system (112) includes parts of, or all of, one or more integrated circuits (ICs) and/or other circuitry components. For example, a processing system for a mutual capacitance sensor may include transmitter circuitry configured to transmit signals with transmitter sensor electrodes, and/or receiver circuitry configured to receive signals with receiver sensor electrodes. Further, a processing system for an absolute capacitance sensor may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor may include any combination of the above described mutual and absolute capacitance circuitry. In some embodiments, the processing system (112) also includes electronically-readable instructions, such as firmware code, software code, and/or the like. In some embodiments, components composing the processing system (112) are located together, such as near sensing element(s) of the device (100). In other embodiments, components of processing system (112) are physically separate with one or more components close to the sensing element(s) of the input device (100), and one or more components elsewhere. For example, the device (100) may be a peripheral coupled to a computing device, and the processing system (112) may include software configured to run on a central processing unit of the computing device and one or more ICs (perhaps with associated firmware) separate from the central processing unit. As another example, the device (100) may be physically integrated in a mobile device, and the processing system (112) may include circuits and firmware that are part of a main processor of the mobile device. In some embodiments, the processing system (112) is dedicated to implementing the device (100). In other embodiments, the processing system (112) also performs other functions, such as operating display screens, etc.

The processing system (112) may be implemented as a set of modules that handle different functions of the processing system (112). Each module may include circuitry that is a part of the processing system (112), firmware, software, or a combination thereof. In various embodiments, different combinations of modules may be used.

Although FIG. 1 shows the processing system (112) including a sensor analysis engine (126), an alignment engine (128) and a feedback generator (130), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as display screens, data processing modules, reporting modules for reporting information, and identification modules configured to identify probe (e.g., 106a, 106b) placement onto a zone (e.g., 104a, 104b) and input to a zone (e.g., 104a, 104b). Further, the various modules may be combined in separate integrated circuits. For example, a first module may be included at least partially within a first integrated circuit and a separate module may be included at least partially within a second integrated circuit. Further, portions of a single module may span multiple integrated circuits. In some embodiments, the processing system as a whole may perform the operations of the various modules.

The sensor analysis engine (126) may include functionality to detect the placement of a probe (e.g., 106a, 106b) in a zone, determine signal to noise ratio, determine positional information of a probe (e.g., 106a, 106b) relative to a zone (e.g., 104a, 104b) and/or relative to other probes (e.g., 106a, 106b), detect pressure input from a probe (e.g., 106a, 106b) (e.g., corresponding to a zone (e.g., 104a, 104b) press, such as pressing a key on a keyboard, or pressing a button on an equipment faceplate), and/or perform other operations.

The sensor analysis engine (126) may include functionality to drive the sensing elements to transmit transmitter signals and receive the resulting signals. For example, the sensor analysis engine (126) may include sensory circuitry that is coupled to the sensing elements. The sensor analysis engine (126) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

In some embodiments, the sensor analysis engine (126) may digitize analog electrical signals obtained from the sensor electrodes. Alternatively, the sensor analysis engine (126) may perform filtering or other signal conditioning. As yet another example, the sensor analysis engine (126) may subtract or otherwise account for a baseline, such that the information reflects a difference between the electrical signals and the baseline. As yet further examples, the sensor analysis engine (126) may determine positional information of one or more probes (e.g., 106a, 106b), recognize inputs as commands, recognize handwriting, and the like.

In one or more embodiments of the invention, the sensor analysis engine (126) may interpret the motion of the probe (e.g., 106a, 106b), as detected by motion sensors (120). For example, a pattern of motion sensor (120) data may correspond to a gesture (e.g., a quick tapping gesture).

In one or more embodiments of the invention, an alignment engine (128) interprets the information obtained by the sensor analysis engine (126) to determine the alignment of one or more probes (e.g., 106a, 106b) relative to a target position, and/or relative to the position of other probes (e.g., 106a, 106b), which may be represented in terms of distance, or an adjacency relationship (e.g., index finger to the right of the middle finger). For example, the alignment engine (128) may determine that the “wrong” type of probe (e.g., 106a, 106b) is placed in a zone probe (e.g., 104a, 104b) (e.g., index finger is resting on the “G” key rather than the “F” key on a QWERTY keyboard), or that an insufficient number of probes (e.g., 106a, 106b) are placed within a zone (e.g., 104a, 104b).

In one or more embodiments of the invention, the alignment engine (128) provides a target position for a probe (e.g., 106a, 106b) to the feedback generator (130), which generates a response designed to guide the probe (e.g., 106a, 106b) toward the target position, when the probe (e.g., 106a, 106b) is not already within a predetermined tolerance relative to that position. The target position may be the center or centroid of a zone (e.g., 104a, 104b), or a set of zones (e.g., 104a, 104b). Alternatively, the target position may be a zone (e.g., 104a, 104b) boundary or any other point in the zone (e.g., 104a, 104b).

In one or more embodiments of the invention, the feedback generator (130) generates response waveforms expressed through vibrating actuators (122) and/or other effectors (110). In one or more embodiments of the invention, the response depends on the context, where the context may include a task being performed by a probe (e.g., 106a, 106b). In one or more embodiments of the invention, the feedback generator (130) generates haptic, electrostatic and/or other types of responses in one or more zones (e.g., 104a, 104b) to guide one or more probes (e.g., 106a, 106b) toward their respective target positions as determined by the alignment engine (128). In one or more embodiments of the invention, each response may span the entire device (100), while in other embodiments each response may be localized to a zone (e.g., 104a, 104b) on the surface (102) of the device (100).

As shown in FIG. 1, the computer system (100) includes a processor (114). A processor (114) may refer to single-core processors or multi-core processors. In one or more embodiments of the invention, a processor (114) is any hardware capable of, at least in part, executing sequences of instructions (e.g., the instructions of a computer program) in a computer system (100). In one or more embodiments of the invention, a processor (114) is a collection of electronic circuitry capable of implementing various actions (e.g., arithmetic, Boolean logic, move data, etc.) in order to carry out instructions (e.g., write to a variable, read a value, etc.). For example, a processor (114) may be a microprocessor fabricated, at least in part using a semiconducting material, as one or more integrated circuits.

The device (100) may include substantially transparent sensor electrodes overlaying the display screen and provide a touchscreen interface for the associated electronic system. The display screen may be any type of dynamic display capable of displaying a visual interface to a user, and may include any type of light-emitting diode (LED), organic LED (OLED), cathode ray tube (CRT), liquid crystal display (LCD), plasma, electroluminescence (EL), or other display technology. The device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (112).

It should be understood that while many embodiments of the invention are described in the context of a fully-functioning apparatus, the mechanisms of the present invention are capable of being distributed as a program product (e.g., software) in a variety of forms. For example, the mechanisms of the present invention may be implemented and distributed as a software program on information-bearing media that are readable by electronic processors (e.g., non-transitory computer-readable and/or recordable/writable information bearing media that is readable by the processing system (112)).

Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system (112) and/or the device may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

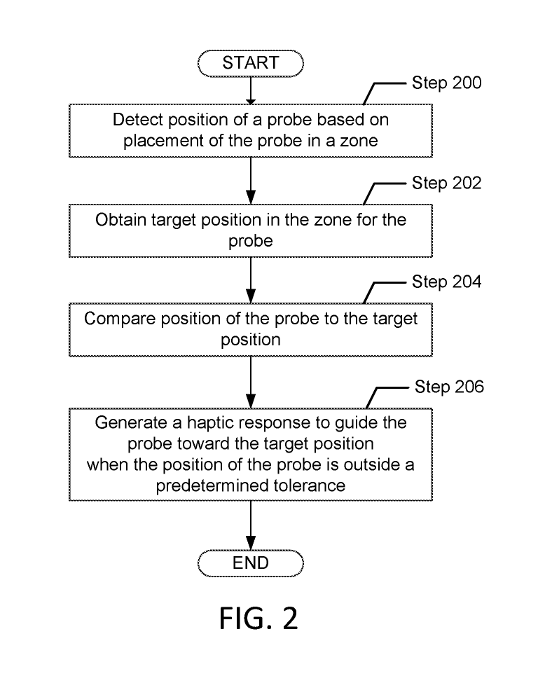

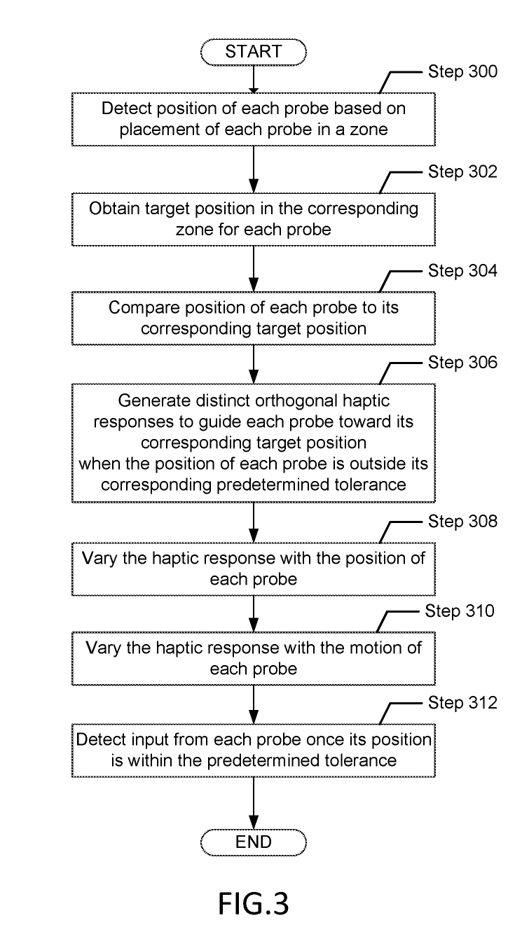

FIG. 2 and FIG. 3 show flowcharts in accordance with one or more embodiments of the invention. Specifically, one or more steps in FIG. 2 and FIG. 3 may be performed by the processing system as described in FIG. 1. While the various steps in this flowchart are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

Turning to the flowchart of FIG. 2, in Step 200 the position of a probe is detected based on a placement of the probe in a zone on a surface of a device. In accordance with one or more embodiments of the invention, as discussed earlier, the detection may be implemented via position sensors, such as capacitive sensors.

In Step 202, a target position in the zone is obtained for the probe, where the target position may depend on a task associated with the probe and/or zone. In accordance with one or more embodiments of the invention, as discussed earlier, the determination may be implemented via a processing system coupled to the device.

In Step 204, the position of the probe is compared to the target position. The difference between the position of the probe and the target position is then compared to a predetermined tolerance. In accordance with one or more embodiments of the invention, the comparison may be implemented via a processing system coupled to the device.

In Step 206, a haptic response is generated to guide the probe toward the target position, when the difference between the position of the probe and the target position is outside the predetermined tolerance. In accordance with one or more embodiments of the invention, as discussed earlier, the haptic response may be implemented via effectors coupled to the device, such as vibrating actuators. In one or more embodiments of the invention, the response may be an electrostatic response, or any other type of response detectable by the senses. In one or more embodiments of the invention, the response continues until the difference between the position of the probe and the target position is within the predetermined tolerance. In one or more embodiments of the invention, the amplitude, frequency, phase and/or pulse width of the haptic response depend on the distance between the probe's position and the target position, where the response varies as the probe approaches or recedes from the target position. In one or more embodiments, the haptic response varies linearly with the distance between the probe's position and the target position. In one or more embodiments, once the difference between the position of the probe and the target position is within the predetermined tolerance, a special haptic response may be generated to indicate successful positioning of the probe.

In one or more embodiments of the invention, the haptic response may be used to convey information about the status of the device and/or a task associated with the device. For example, a certain haptic response (e.g., a constant buzz) may indicate that a function associated with a specific zone is disabled and no longer available. Or a certain haptic response may indicate a warning or error condition, or alternatively, the current status or successful completion of a task by a probe on a device. In one or more embodiments of the invention, a haptic response may be provided to indicate whether the wrong probe types (e.g., wrong fingers), or an insufficient number of probes are placed in a zone, relative to a context which may include a task associated with the probes and/or the zone. Once it is possible to distinguish among different haptic signals, it then becomes possible to support a haptic vocabulary of distinct haptic signals, where the various elements of the haptic vocabulary may be assigned meaning within the context of tasks performed by probes on a device. For example, a probe controller may interpret a haptic response received by a probe in order to determine subsequent placement of the probe and subsequent probe input, which may be based on a task that the probe is performing.

In one or more embodiments of the invention, instead of aligning the position of a probe relative to a zone, the position (e.g., center) of the zone itself may be aligned relative to a probe. For example, a user may place his or her fingers on a surface and one or more zones (e.g., QWERTY zones on a keyboard) may align themselves to adapt in size and location around the fingers, to provide the sensation that the keys have re-aligned underneath the fingers. Haptic feedback may be used to indicate that the zone re-alignment has been initiated and/or has been completed. For example, in robotic applications it may be easier to align the zones relative to robot probes, rather than viceversa.

For example, in one or more embodiments, an initial zone position may be obtained based on a history of probe touches to the surface. In one or more embodiments, a zone target position may be determined based on the placement of a probe relative to the zone. The initial position of the zone may be compared to the zone target position in order to determine whether to move the zone to the zone target position. For example, the zone may be moved to the zone target position when the initial position of the zone is outside a predetermined tolerance relative to the zone target position. In one or more embodiments, a haptic response may be generated in the zone once the zone begins moving. And a haptic response may be generated in the zone once the zone is within the predetermined tolerance.

FIG. 3 shows a flowchart describing, in more detail, the method of FIG. 2, in accordance with one or more embodiments of the invention. The method of FIG. 3 adds detail to the method of FIG. 2, a key difference being that FIG. 3 addresses a scenario with multiple probes and multiple haptic responses.

Turning to the flowchart of FIG. 3, in Step 300 (similar to Step 200) the position of one or more probes is detected based on a placement of each probe in a zone on a surface of the device.

In Step 302 (similar to Step 202), a target position in a zone is obtained for each probe. In one or more embodiments of the invention, the target position may be represented in terms of relative coordinates, for example, where the coordinates specify a distance from another probe. In one or more embodiments of the invention, the target position may be represented in terms of one or more adjacency relationships relative to one or more other probes (for example, to the left of the right index finger, where the type of finger may be determined by the shape of the finger's signature area when placed on the zone).

In one or more embodiments of the invention, a processing system dynamically selects target positions to align multiple probes in a predetermined configuration of positions relative to a set of zones. In one or more embodiments of the invention, the predetermined configuration may relate to the synchronization of concurrent or sequential activity by one or more probes in one or more zones to perform a task. For example, multiple probes may require alignment prior to performing a task requiring synchronized action by the multiple probes. Furthermore, the multiple probes may require re-alignment and re-placement as the execution of the task proceeds, in which case additional haptic responses may be dynamically generated to guide the multiple probes toward their new target positions.

In Step 304 (similar to Step 204), the position of each probe is compared to the corresponding target position. The difference between the position of each probe and the corresponding target position is then compared to a predetermined tolerance.

In Step 306 (similar to Step 206), a haptic response is generated to guide each probe toward its corresponding target position, when the difference between the position of the probe and its corresponding target position is outside the predetermined tolerance. In one or more embodiments of the invention, the individual haptic responses provided to each probe are orthogonal, such that the individual haptic responses may be concurrently and independently detected by individual probes touching the surface of the device. In one or more embodiments of the invention, an orthogonal response may be achieved by localizing each response to a specific zone. For example, a distinct haptic shake or physical “click” may be generated as a probe arrives at the edge of the zone, thus giving the impression of a zone boundary. As the probe exits the zone, a second haptic shake may provide the impression of leaving one zone and entering an adjacent zone.

In one or more embodiments of the invention, orthogonal responses may be generated using a variety of modulation techniques, including but not limited to: frequency modulation, phase modulation, amplitude modulation and/or pulse modulation. For example, it is easier for two different probes to detect two distinct haptic responses when each haptic response is modulated using frequencies that are not close together in the frequency spectrum. Alternatively, the haptic responses may be modulated such that the haptic responses are out of phase.

Using the example of fingers as probes, just as ears can hear and distinguish two musical notes at once, fingers can sense multiple vibrating frequencies and distinguish among them. The frequency does not refer to the actuator frequency, but rather the modulation of the actuator frequency. For example, if the actuator vibrates at freqX, this can be modulated by turning the actuator on/off at a second freqY (e.g., twice per second). A second freqZ can be added to achieve freqY+freqZ. The user can distinguish freqY and freqZ independently though a single finger. If freqY and freqZ are too close in frequency, the separate responses are more difficult to distinguish. To increase orthogonality, freqY can be a repeating pattern of on/off such as on/on/off/on and the frequency of the overall pattern can be increased or decreased. Orthogonality may also be achieved via phase modulation, for example, where freqY can be 1 Hz and freqZ can also be 1 Hz, where each frequency has a different phase. When both frequencies beat in phase, one simply senses a 1 Hz vibration, and distinct responses cannot be easily discerned.

In Step 308, the haptic response varies with the difference between the position of each probe and its corresponding target position, as detected by position sensors.

In Step 310, the haptic response varies with the motion of each probe, as detected by motion sensors. For example, the response may depend on the length of time the probe is in contact with the zone (e.g., a quick tapping gesture will result in a different response than prolonged contact).

In Step 312, input is detected from one or more probes based on pressing a probe in a zone on a surface of the device. In accordance with one or more embodiments of the invention, as discussed earlier, the input detection may be implemented via pressure sensors. In one or more embodiments of the invention, there may be operative dependencies between the touch sensors used to detect probe placement, and pressure sensors used to detect probe input. For example, in one or more embodiments of the invention, activation of a pressure sensor in a zone may temporarily disable the position sensors in that zone (e.g., once a zone is pressed by a probe it is no longer necessary to track the placement of the probe relative to that zone). In one or more embodiments of the invention, the processing system may interpret probe input differently depending on the context, where the context may include a task being performed by the probe (e.g., where the meaning of activating a zone by a probe depends on the state of the device and/or the state of a task being performed on the device).

The following examples are for explanatory purposes only and not intended to limit the scope of the invention.

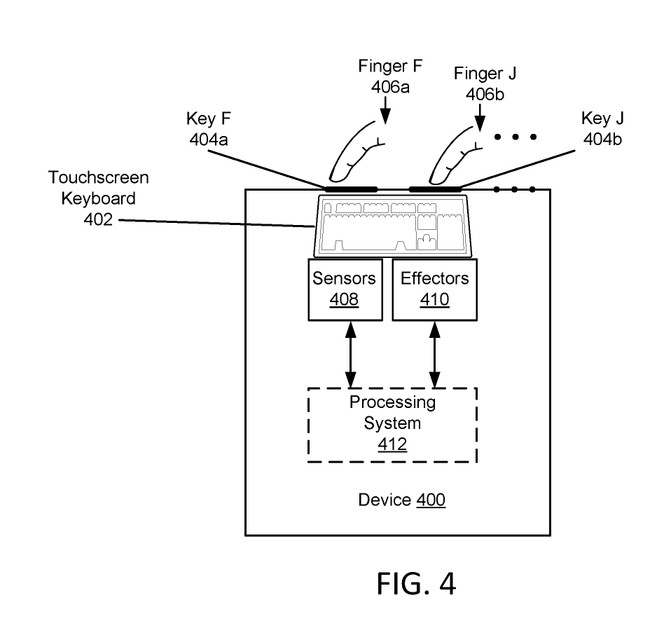

FIG. 4 shows an example device (400) (e.g., a tablet computer or other computing device), in accordance with one or more embodiments of the invention, where the device (400) includes a touchscreen keyboard (402) which includes a set of keys (404a, 404b) which interact with one or more of a user's fingers (406a, 406b). The processing system (412) guides the user's fingers (406a, 406b), via haptic feedback provided by the effectors (410), to be centered on the touchscreen keyboard (402) without requiring the user to look at the keyboard (402). Sensors (408) detect when the user's fingers (406a, 406b) are lightly touching keys (404a, 404b), such as the reference letters F and J, with light force, while keypresses on any key (404a, 404b) are not registered until a stronger force is used. When the F finger (406a) lightly touches the outer perimeter of the F key (404a), a haptic frequency of FREQ1low is initiated by the effectors (410). As the F finger (406a) moves closer to the center of the F key (404a), the haptic frequency increases to FREQ1high. When the J finger (406b) lightly touches the outer perimeter of the J key (404b), a haptic frequency of FREQ2low is initiated. As the J finger (406b) moves closer to the center of the J key (404b), the haptic frequency increases to FREQ2high. Orthogonal frequencies, not close together in the frequency spectrum, are selected so that the frequencies may be separately discerned by the user, even when both frequencies are simultaneously present. The haptic feedback allows the user to center his or her fingers on the appropriate keys (404a, 404b), without requiring visual feedback. The touch and pressure sensitive screen (402) allows the keys (404a, 404b) to be touched lightly without registering a keypress until a stronger force is used.

The haptic feedback capability is also useful when a touchscreen (402) is mounted on a vertical surface in front of a user rather than in the user's lap, where the user's arm articulates from the shoulder, making it more difficult to center one's fingers (406a, 406b) on small buttons or keys (404a, 404b). The ability to rest one's finger(s) on the surface and center the finger(s) accurately without causing a keypress allows a user to accurately find and press keys (404a, 404b) in environments where the user's arm experiences vibration or where the user's arm is extended far in front of the user's body. In addition, existing physical keyboards can benefit from haptic feedback, where reliable alignment of users' fingers may increase the accuracy and ease of typing, and reduce the occurrence of fingers “drifting” (e.g., when providing hover input).

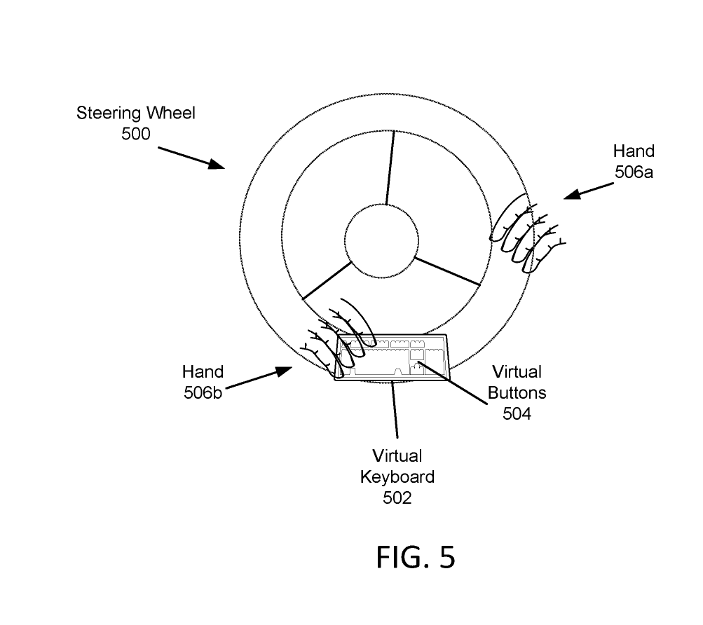

FIG. 5 shows an example steering wheel (500), in accordance with one or more embodiments of the invention, where the steering wheel (500) includes a virtual keyboard (502) with buttons (504) which interact with one or more of a user's fingers or hands (506a, 506b). Instead of having physical buttons in the center spokes of the steering wheel (500) (which requires taking one's hand off the wheel), virtual haptically-located buttons (504) may be located on the steering wheel (500) itself. The layout of these buttons (504) may be dynamically determined relative to the location of the user's palms. The function and configuration of these buttons (504) may dynamically vary depending on the context of the driving environment (e.g., vehicle speed, engine temperature, cabin temperature, oil level, road, and weather conditions). Thus, the virtual keyboard may function as a type of makeshift, dynamically configured, instrument panel. The keyboard (502) may be activated by a gesture, such as a finger tap, and then the buttons (504) located following the guidance of haptic feedback.

Although driver-assisted cars are able to drive themselves, they may require both hands on the steering wheel (500), and if one takes his or her hands (506a, 506b) off the steering wheel (500), the driver-assistance feature may deactivate. Therefore, it may be advantageous to locate a touch-sensitive virtual keyboard (502) on the steering wheel (500) itself. The virtual keyboard (502) may be used for various input functions, and may also be used to ensure that the driver is actually gripping the steering wheel (500) (e.g., by tapping a code or providing a gesture at regular time intervals).

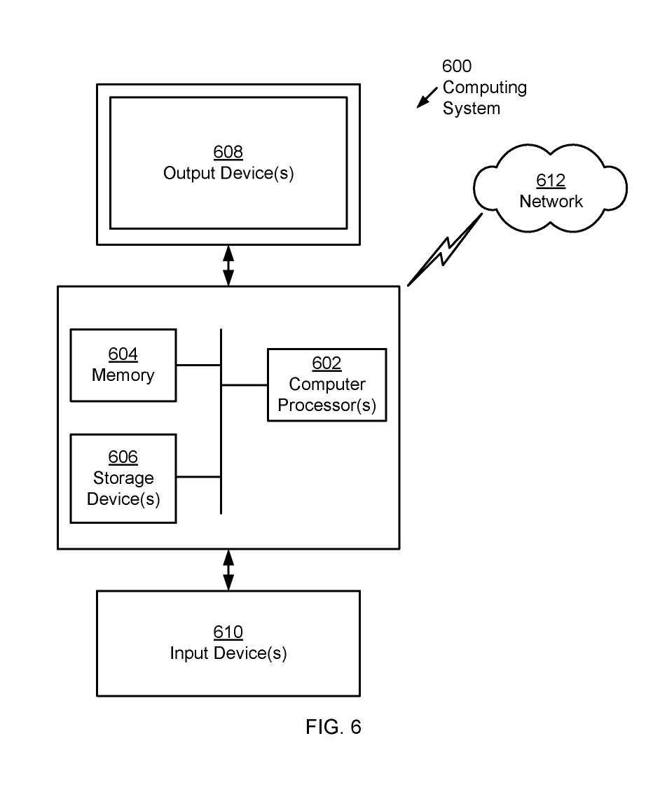

Embodiments of the invention may be implemented on a computing system. Any combination of mobile, desktop, server, embedded, or other types of hardware may be used. For example, as shown in FIG. 6, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
detecting a position of a first probe based on a placement of the first probe relative to a first zone on a surface of a device;
obtaining a first target position for the first probe in the first zone;
comparing the position of the first probe to the first target position; and
generating a first haptic response to guide the first probe toward the first target position when the position of the first probe is outside a first predetermined tolerance relative to the first target position, the first haptic response varying with the position of the first probe.

2. The method of claim 1, further comprising detecting a first input from the first probe based on pressing the first probe in the first zone.

3. The method of claim 1, further comprising modulating the first haptic response.

4. The method of claim 1, further comprising detecting the motion of the first probe, wherein the first haptic response is based, in part, on the detected motion.

5. The method of claim 1, further comprising generating an electrostatic response to guide the first probe toward the first target position when the position of the first probe is outside the first predetermined tolerance.

6. The method of claim 1, further comprising:
detecting a position of a second probe based on a placement of the second probe relative to a second zone on a surface of the device;
obtaining a second target position for the second probe in the second zone;
comparing the position of the second probe to the second target position; and
generating a second haptic response to guide the second probe toward the second target position when the position of the second probe is outside a second predetermined tolerance relative to the second target position, wherein the second haptic response varies with the position of the second probe.

7. The method of claim 1, further comprising:
obtaining an initial position of the first zone;
determining a zone target position for the first zone based on the placement of the first probe relative to the first zone;
comparing the initial position to the zone target position;
moving the first zone to the zone target position when the initial position is outside a predetermined zone tolerance relative to the zone target position; and
generating a zone haptic response in the first zone once the first zone is within the predetermined zone tolerance relative to the zone target position.

8. The method of claim 6, further comprising modulating the first haptic response and modulating the second haptic response, wherein the modulated first haptic response and the modulated second haptic response are orthogonal.

9. A device comprising:
a surface, configured to contact a first probe;
a position sensor, configured to detect a position of the first probe based on a placement of the first probe relative to a first zone on the surface;
a processor comprising an alignment engine, configured to obtain a first target position for the first probe in the first zone, compare the position of the first probe to the first target position, and determine that the position of the first probe is outside a first predetermined tolerance relative to the first target position; and
a plurality of vibrating actuators, configured to generate a first haptic response to guide the first probe toward the first target position when the position of the first probe is outside a first predetermined tolerance relative to the first target position, the first haptic response varying with the position of the first probe.

10. The device of claim 9, further comprising a pressure sensor, configured to detect a first input from the first probe based on pressing the first probe in the first zone.

11. The device of claim 9, wherein the plurality of vibrating actuators is further configured to modulate the first haptic response.

12. The device of claim 9, further comprising a motion sensor, configured to detect the motion of the first probe, wherein the first haptic response is based, in part, on the detected motion.

13. The device of claim 9, further comprising an electrostatic effector, configured to generate a first electrostatic response to guide the first probe toward the first target position when the position of the first probe is outside a first predetermined tolerance relative to the first target position, wherein the first electrostatic response varies with the position of the first probe.

14. The device of claim 9,
wherein the surface is further configured to contact a second probe;
wherein the position sensor is further configured to detect a position of the second probe based on a placement of the second probe relative to a second zone on the surface of the device;
wherein the alignment engine is further configured to obtain a second target position for the second probe in the second zone, compare the position of the second probe to the second target position, and determine that the position of the second probe is outside a second predetermined tolerance relative to the second target position; and
wherein the plurality of vibrating actuators is further configured to generate a second haptic response to guide the second probe toward the second target position when the position of the second probe is outside a second predetermined tolerance relative to the second target position, wherein the second haptic response varies with the position of the second probe.

15. The device of claim 14,
wherein the alignment engine is further configured to obtain an initial position of the first zone, determine a zone target position for the first zone based on the placement of the first probe relative to the first zone, compare the initial position to the zone target position, and move the first zone to the zone target position when the initial position is outside a predetermined zone tolerance relative to the zone target position; and
wherein the plurality of vibrating actuators is further configured to generate a zone haptic response in the first zone once the first zone is within the predetermined zone tolerance relative to the zone target position.

16. The device of claim 14, wherein the plurality of vibrating actuators is further configured to modulate the first haptic response and the second haptic response, wherein the modulated first haptic response and the modulated second haptic response are orthogonal.

17. A processing system for a device comprising:
a sensor analysis engine, configured to analyze sensor data to compute the position of a first probe, and to interpret input from the first probe;
an alignment engine, configured to obtain a first target position for the first probe in the first zone, compare the position of the first probe to the first target position, and determine that the position of the first probe is outside a first predetermined tolerance relative to the first target position; and
a feedback generator, configured to generate a first haptic response to guide the first probe toward the first target position when the position of the first probe is outside a first predetermined tolerance relative to the first target position, the first haptic response varying with the position of the first probe.

18. The processing system of claim 17, wherein the feedback generator is further configured to modulate the first haptic response.

19. The processing system of claim 17, wherein the feedback generator is further configured to generate a first electrostatic response to guide the first probe toward the first target position when the position of the first probe is outside a first predetermined tolerance relative to the first target position, wherein the first electrostatic response varies with the position of the first probe.

20. The processing system of claim 17,
wherein the sensor analysis engine is further configured to compute the position of a second probe, and to interpret input from the second probe;
wherein the alignment engine is further configured to obtain a second target position for the second probe in the second zone, compare the position of the second probe to the second target position, and determine that the position of the first probe is outside a first predetermined tolerance relative to the first target position; and
wherein the feedback generator is further configured to generate a second haptic response to guide the second probe toward the second target position when the position of the second probe is outside a second predetermined tolerance relative to the second target position, the second haptic response varying with the position of the second probe.
